(19) United States
(12) Patent Application Publication
(10) Pub. No.: US 2026/0029067 A1
(43) Pub. Date: Jan. 29, 2026

(54) An Automated Drain Apparatus, a Tap and a Vessel

(71) Applicant: CheMastery Group Ltd, London (GB)

(72) Inventors: Lara Natasha DODD, London (GB); Stefan GLATZEL, London (GB)

(21) Appl. No.: 18/993,378

(22) PCT Filed: Jul. 12, 2023
(86) PCT No.: PCT/GB2023/051828

§ 371 Date: Jan. 10, 2025

(30) Foreign Application Priority Data
Jul. 12, 2022 (GB) 2210249.5

(51) Int. Cl. F16K 31/50; F16K 31/04; F16K 31/53

(52) U.S. Cl. CPC F16K 31/504; F16K 31/046; F16K 31/53

(57) ABSTRACT

An automated drain apparatus is provided for use with a vessel including a valve the automated drain apparatus including: a motor; a worm screw coupled to the motor, wherein the motor causes a rotation of the worm screw; and a worm wheel, coupled to the worm screw, wherein the rotation of the worm screw causes a rotation of the worm wheel, wherein the worm wheel is configured to couple to a closing mechanism of the valve so that a rotation of the worm wheel causes a movement of the closing mechanism in the valve to control flow of a fluid out of the vessel.

### FIELD

Embodiments described herein relate to an automated drain apparatus, a tap and a vessel.

### BACKGROUND

Chemical vessels, such as those used for chemical reactions, chemical storage, purification or separation, often comprise a tap on the vessel to allow the chemical within the vessel to be removed. The chemical within the vessel may be required for use in another vessel, for example for another reaction, and/or it may be required to remove the chemical safely. Precise and safe opening of valves and control of chemical removal from the vessel is not always achievable using manual taps. There is a need for controlled, automated opening of chemical vessels to enable chemicals to safely and precisely pass from one vessel to another. Current means of opening of valves on chemistry vessels include manual unscrewing, for example by a chemist and air actuated drain valves.

Air actuated pistons require external compressed air, either by a compressor or by a high pressure air line in the lab. This adds an extra complexity. In the common case of using a compressor, this will take up a large amount of space, will be extremely loud and will increase the maintenance requirements for the equipment.

With a pneumatic piston actuated bung, there are only two positions of the valve-fully open, or fully closed. Without the ability to gradually open the valve like with manual opening, precision is compromised.

### SUMMARY

According to a first aspect of the invention, there is provided an automated drain apparatus for use with a vessel comprising a valve, the automated drain apparatus comprising: a motor, a worm screw coupled to the motor, wherein the motor causes a rotation of the worm screw; and a worm wheel, coupled to the worm screw, wherein the rotation of the worm screw causes a rotation of the worm wheel, wherein the worm wheel is configured to couple to a closing mechanism of the valve so that a rotation of the worm wheel causes a movement of the closing mechanism in the valve to control flow of a fluid out of the vessel.

In an embodiment, the vessel is for use in chemical synthesis. In an embodiment, the vessel is a reaction vessel.

In an embodiment, the closing mechanism comprises a plunger, a gate, a ball, or a disc. In an embodiment, a plane of rotation of the worm screw is perpendicular to a plane of rotation of the worm wheel.

In an embodiment, the closing mechanism is a plunger or a gate and a plane of rotation of the worm wheel is perpendicular to a direction of movement of the closing mechanism.

In an embodiment, the closing mechanism is a ball or a disc, and a plane of rotation of the worm wheel is parallel to a direction of movement of the closing mechanism.

In an embodiment, the automated drain apparatus further comprises a stabilising member coupled between the worm screw and the worm wheel to maintain an alignment between the worm screw and the worm wheel.

In an embodiment, the worm screw has one thread and the worm wheel has 38 teeth.

In an embodiment, the automated drain apparatus further comprises a motor controller, wherein the motor controller is configured to prevent the closing mechanism from overshooting its operational position. For example, the operational positions may be the closed or open positions.

In this embodiment, the motor controller may be configured to monitor the number of rotations of the worm screw (steps) and retrieve from a memory the number of rotations necessary to turn the worm screw to allow control closure of the valve. The number of steps to closure may be determined from a manual initialisation process, by closing the valve and then allowing the worm screw to open the valve and count the rotations of the worm screw, thus the controller is able to close the valve by controlling the worm screw to perform the known number of rotations (steps) to allow closure.

In an alternative embodiment, the automated drain apparatus may further comprise a switch, the switch being configured to detect when the position of a valve is in a trigger position, wherein the motor controller is configured to monitor the number of rotations of the worm screw and retrieve from a memory the number of rotations necessary to turn the worm screw to allow control closure of the valve from the trigger position. This requires a simpler initialisation procedure for the controller, since the number of rotations of the worm screw (steps) from the trigger position to the closure position can be provided to the controller prior to initialisation. Closure of the valve can then be performed by checking for when the valve reaches the trigger position and then advancing the worm screw by the known number of steps to closure. In an embodiment, the switch determines when the valve is in the trigger position by the position of the worm sleeve.

According to a second aspect of the invention, there is provided a tap for a vessel comprising: a valve configured to couple to an opening of a vessel, at least part of the valve in fluid communication with the vessel, the valve comprising: a closing mechanism configured to move so as to control flow of a fluid moving through the valve; and the automated drain apparatus described previously.

In an embodiment, the closing mechanism is a plunger, the valve further comprising: a body port in fluid communication with the vessel; and a drainage port in fluid communication with the body port; wherein the plunger is configured to move within the body port so as to control flow of a fluid moving from the body port to the drainage port.

According a third aspect of the invention, there is provided a vessel for fluids comprising: a vessel configured to hold a fluid, the vessel comprising an opening at a bottom of the vessel when in use; and a tap as described previously.

The disclosed apparatus addresses a technical problem of how to safely and efficiently open vessels, such as those used for chemical synthesis. The disclosed apparatus solves this technical problem by providing an automated drain apparatus that is configured to couple to a valve of a vessel. This allows for controlled opening and closing of the valve. It also facilitates remote opening and closing of the valve, increasing safety for users who do not need to touch or manual open the vessel. The disclosed apparatus may also be retro-fitted onto existing, originally purely manually operated, drain valves in order to automate them.

The disclosed apparatus addresses the unmet need of allowing chemical reactions or processes to take place fully autonomously without human input. This allows the chemical reaction or process to be run at any time of the day and in parallel with chemists doing other work.

### BRIEF DESCRIPTION OF THE DRAWINGS

For a better understanding of the invention and to show how the same may be carried into effect, reference will now be made, by way of example, to the accompanying drawings, in which:

FIG. 1 illustrates a vessel for use in chemical processes or storage;

FIG. 2a illustrates a valve for use with a vessel;

FIG. 2b illustrates a valve for use with a vessel;

FIG. 2c illustrates a valve for use with a vessel;

FIG. 3a illustrates an automated draining apparatus according to an embodiment;

FIG. 3b illustrates an automated draining apparatus according to an embodiment;

FIG. 3c illustrates an automated draining apparatus according to an embodiment;

FIG. 3d illustrates an automated draining apparatus according to an embodiment;

FIG. 3e illustrates an automated draining apparatus according to an embodiment;

FIG. 4a illustrates a vessel screw cap coupled to a vessel according to an embodiment;

FIG. 4b illustrates a vessel screw cap coupled to a vessel according to an embodiment;

FIG. 4c illustrates a partial cross section of the vessel screw cap coupled to both the vessel and the plunger;

FIG. 5 illustrates a vessel in accordance with an embodiment;

FIG. 6 illustrates an automated draining apparatus according to an embodiment;

FIG. 7a illustrates a worm wheel sleeve and switch in accordance with an embodiment;

FIG. 7b is a diagram of a switch;

FIG. 7c is a schematic of a worm sleeve with lever for use in a further embodiment; and

FIG. 8 is a flow chart illustrating the closure process when there is a switch.

### DETAILED DESCRIPTION OF EMBODIMENTS

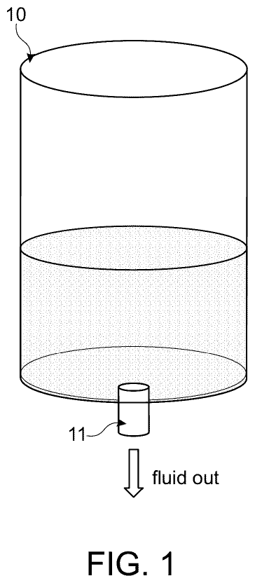

FIG. 1 illustrates a vessel 10 for holding fluid. In an embodiment, the vessel 10 is used in chemical processes such as chemical synthesis, chemical purification, chemical separation, or chemical storage. Purification involves the removal of impurities from a chemical. Separation can include the separation of two immiscible fluids or filtration of solids from a fluid) The vessel 10 can be a reactor, a filtration vessel etc. In an embodiment, the vessel is made of glass. In other embodiments, the vessel 10 is made of plastic or a steel alloy. In an embodiment, the vessel is cylindrical in shape, although other shapes such as a cube, a cuboid or any 3D shape can be used. The vessel 10 holds fluid (shaded portion of FIG. 1). The fluid in such a vessel 10 can be a gas or a liquid. The vessel 10 can have a capacity in the range of hundreds of millilitres to thousands of litres.

The vessel 10 has an opening on the bottom of the vessel (as the vessel is used in normal use). In FIG. 1, the opening is shown as being in the centre of the bottom of the vessel. However, the opening may be offset from the centre of the bottom of the vessel. In another embodiment, the opening may be on a side wall of the vessel 10.

In FIG. 1, the opening is coupled to a valve 11 on the bottom of the vessel. When the valve 11 is opened, the fluid (shaded portion of FIG. 1) contained in the vessel 10 drains out of the vessel under gravity, and into a pipe or another vessel. In an embodiment where the opening, and hence valve, are located on a side wall of the vessel, when the valve 11 is opened, the fluid contained in the vessel 10 that is above the opening drains out of the vessel under gravity. In an embodiment, when the valve 11 is opened the fluid moves out of the vessel 10 due to a pumping action caused by a pump within the vessel or coupled to the vessel 10. In an embodiment, negative pressure is applied to an end of the valve 11 furthest from the vessel 10. This causes the fluid within the valve to drain liquid from the vessel 10. Negative pressure may be used for a closed system, where the vessel 10 is not exposed to air.

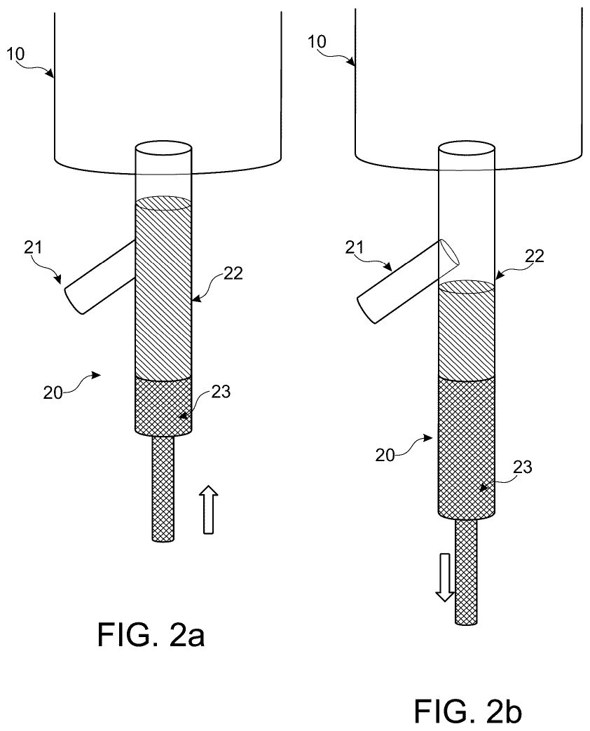

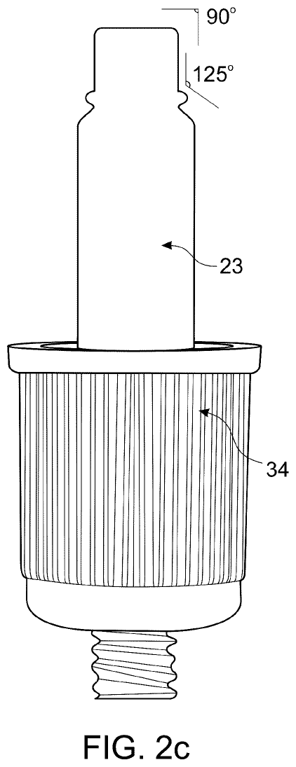

FIGS. 2a and 2b illustrate a valve 20. The valve 20 comprises a drainage port 21 and a body port 22. The valve 20 further comprises a plunger 23 in the body port 22. The plunger 23 shown in FIG. 2a is cylindrical and the internal chamber of the body port 22 is also cylindrical so that the plunger 23 can fit tightly into the body port 23, but can be moved within the body port 23 in a direction towards or away from the vessel 10. However, the plunger 23 and the internal chamber of the body port 22 may be of different shapes so long as (a) the plunger 23 fits the inner chamber of the body port 22 tightly to ensure that no liquid escapes the body port 22 except through the drainage port 21 when in an open position, such as in FIG. 2b, that no liquid escapes the drainage body port 22 when in a closed position, such as in FIG. 2a) the plunger can be moved (advanced and retracted) within the body port 22. In an embodiment, the plunger 23 is needle-shaped. In another embodiment, the plunger 23 is cylindrical with a bezel at the end.

When the plunger 23 is advanced upwards in the direction of the vessel 10 as shown by the arrow (FIG. 2a), it blocks the opening to the drainage port 21, preventing fluid from exiting through the drainage port 21 to a pipe or other vessel. When the plunger 23 is moved down in a direction away from the vessel 10 as shown by the arrow (FIG. 2b), the opening to the drainage port 21 is unblocked, and fluid within the vessel 10 can flow out the drainage port 21 via the body port 22.

The plunger 23 can be advanced upwards and downwards by applying a vertical force to the plunger 23. The plunger 23 can be directly connected to a linear actuator and convert a linear movement of the actuator to a linear movement of the plunger 23. The linear actuator can be electromechanical, mechanical, hydraulic, or pneumatic.

Alternatively, in an embodiment, the plunger 23 can be advanced upwards and downwards by applying a rotational motion to the plunger 23. The plunger 23 is connected to a rotational actuator which translates rotational movement into the linear movement of the plunger 23. In an embodiment, the plunger 23 is on the end of a screw, or an end part of the plunger 23 comprises a screw. The inside of the body port 22 is profiled to accommodate the screw. In an embodiment, the inside of the body port may be threaded to accommodate the threads of the screw.

As the screw is turned in one direction and the plunger 23 retracted, flow between the vessel 10 and the drainage port 21 is possible. As the screw is turned in the opposite direction, flow between the vessel 10 and the drainage port 21 is inhibited. Since it takes many turns of the fine-threaded screw to retract or advance the plunger 23 in the body port 22, precise regulation of the flow rate of the fluid out of the vessel 10 is possible.

Alternatively, in an embodiment, the plunger 23 is not on the end of a screw, or does not comprise a screw of threaded portion. In this embodiment, the plunger 23 is pressure actuated to move (with respect to FIG. 2a and FIG. 2b, this is a vertical movement) within the body port 22 to inhibit flow between the vessel 10 and the drainage port 21.

In FIG. 2a and FIG. 2b, the plunger 23 is shown as being of cylindrical shape. In an embodiment the diameter of the plunger 23 is between 4 mm and 100 mm. In an embodiment the diameter of the plunger 23 is 12 mm. In an embodiment the diameter of the plunger 23 is 15 mm. In another embodiment, the diameter of the plunger is 20 mm. The choice of plunger 23 diameter is proportional in relation to the vessel size and capacity. Alternately, the plunger 23 can be needle shaped, or pointed. FIG. 2c shows an embodiment where the plunger is cylindrical with a bezel at the end. This bezel presses against a bezel in the body port 22 of the vessel 10 to provide a seal. The bezel makes an angle of 125° with the central axis of the plunger 23 In FIG. 2a and FIG. 2b, the body port is shown as being of cylindrical shape comprising a cylindrical cavity to accommodate a cylindrical plunger. Alternatively, the inside of the body port 22 may comprise a cavity profiled to accommodate a needle-shaped plunger or other shaped plunger. The shape of the plunger 23 is configured to enable the drainage port 21 to be blocked off to, partly blocked off to or opened up to fluid flow from the vessel 10.

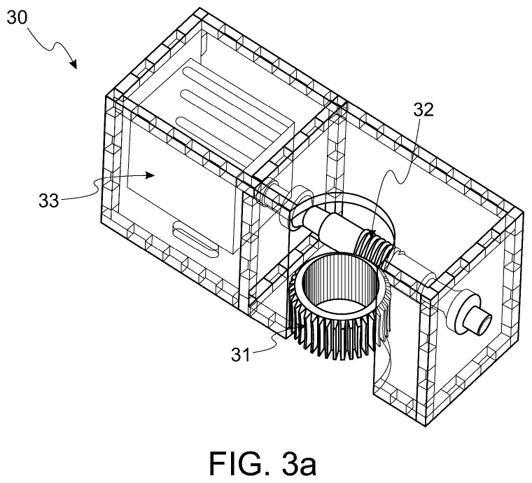

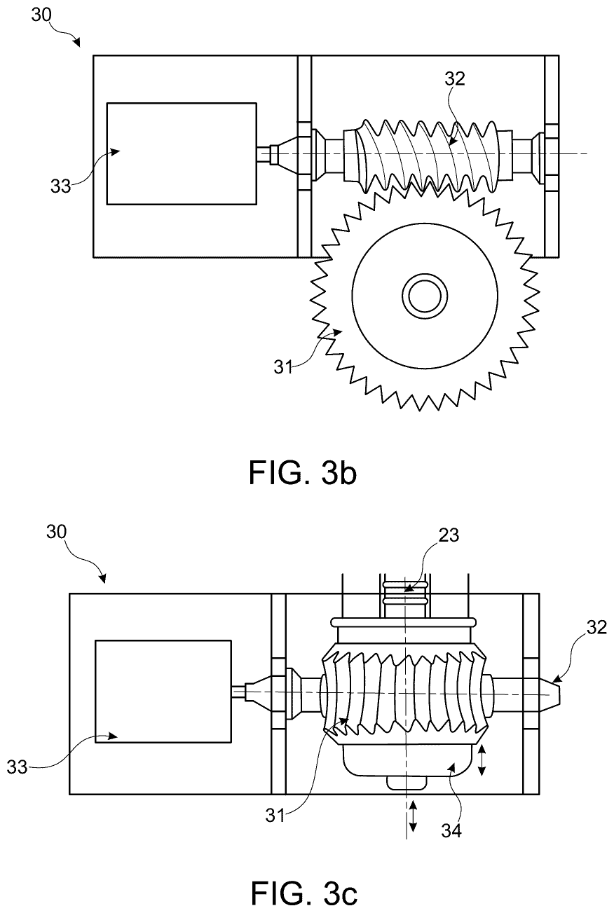

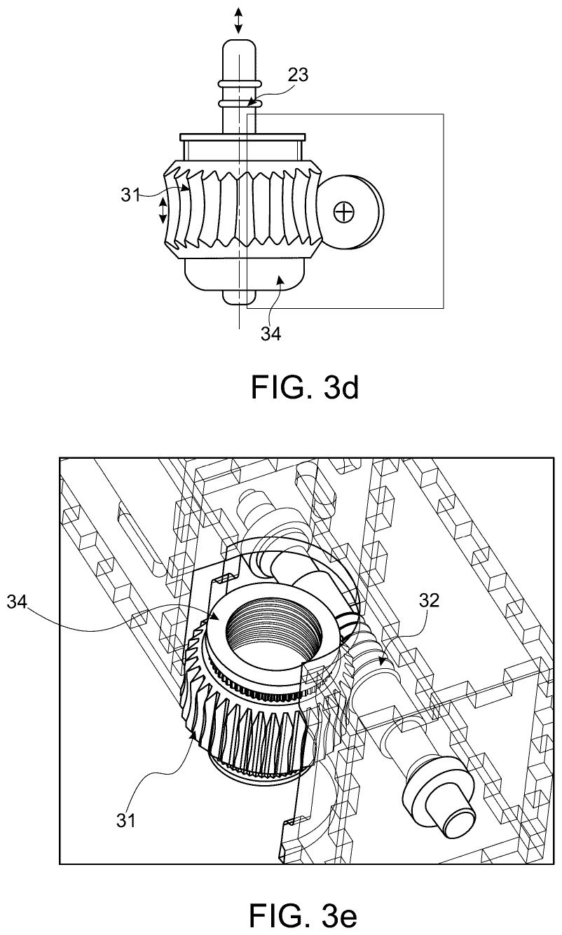

FIGS. 3a to 3c illustrate an automated drain apparatus 30 according to an embodiment. The apparatus 30 may be used with a valve 20 such as that illustrated in FIG. 2A and FIG. 2B. The apparatus 30 comprises a worm wheel sleeve 31 configured to couple to the plunger 23 of the valve 20. The apparatus 30 further comprises a worm screw 32 coupled to a motor 33.

The motor 33 produces sufficient force to turn the worm screw 32. There is little to no holding torque required. The motor 33 can be a stepper motor or a (brushless) DC motor.

The worm wheel sleeve 31 couples to the worm screw 32. The worm screw 32 comprises a threaded shaft. The worm wheel sleeve 31 comprises a number of teeth. The threaded shaft of the worm screw 32 and at least one tooth of the teeth of the worm wheel sleeve 31 are coupled together.

The worm screw 32 is actuated by a motor 33. When the worm screw 32 is rotated by the motor 33 about its drive axis, which coincides with a central axis of the shaft, it causes the worm wheel sleeve 31 to rotate as the drive axis of the worm wheel sleeve 31 is at 90° to the drive axis of the worm screw 32.

In an embodiment, the drive axis of the motor 33 can be at a non-zero angle with respect to the central axis of the shaft. In an embodiment, this can be achieved using bevel gears. In an embodiment, miter gears can be used. Miter gears are a type of bevel gear where the two rotational axes intersect. Their purpose is to cause a change in transmission direction.

The miter gears may have a 90 degree angle or a non-90 degree (non-perpendicular) angle. The use of the miter gears would considerable reduce the space requirement as the motor 33 could fit entirely under the vessel 10 rather than sticking out to the side.

In an embodiment, the motor 33 couples to a first gear of the miter gear. The first gear couples to a second gear of the miter gear, causing a change in the direction of the rotation caused by the motor 33. In an embodiment, the second gear couples to worm screw 32. In an embodiment, the second gear is the worm screw 32.

As shown in FIG. 3c and FIG. 3d, the worm wheel sleeve 31 is coupled to the plunger 23 of the valve 20. The rotation of the worm wheel sleeve 31 causes the plunger 23 of the valve 20 to move in a vertical direction perpendicular to the plane of the rotational movement, either towards or away from the vessel depending on the direction of the rotational movement. In the embodiment, the worm wheel sleeve 31 is coupled to a screw or threaded portion of the plunger 23. As the worm wheel sleeve 31 rotates, the threaded portion engages with a threaded portion of the body port 22 of the valve 20 to cause the plunger 23 to move in a vertical direction.

The worm screw 32 may have one or more threads, or helices, on the shaft. The worm wheel sleeve 31 comprises a number of teeth. For a worm screw 32 with a single thread, for each 360° turn of the worm screw 32, the worm wheel sleeve 31 advances by only one tooth.

In an embodiment, the gear ratio is in the range 2:1 to 38:1, where the gear ratio is the ratio of teeth of the worm wheel sleeve 31 to threads of the worm screw 32. In an embodiment, the gear ratio is in the range 20:1 to 38:1. In a further embodiment, the gear ratio is 38:1, so that the worm wheel sleeve 31 comprises 38 teeth and the worm screw 32 comprises a single thread.

The following factors may be considered in selecting a gear ration:
torque needed—for example, a higher gear ratio will enable a lower power motor to be used;
force needed to move the plunger—for example, a 10 cm teflon plunger on glass is light and has very little friction, but closing a 10000 L vessel with a 30 cm steel plunger will require substantially more force;
speed vs precision-if speed is of the essence for an application choosing the gears and thread angle such that one rotation of the worm gear results in a greater plunger movement; and
a multi-start thread could be used to achieve a faster movement while retaining the same pitch.

The worm wheel sleeve 31 and worm screw 32 are scaled up/down in size for different sized chemical vessels. One full rotation of the worm screw 32 moves the worm wheel sleeve by one tooth (9.5 degrees). Assuming the plunger moves a vertical distance of 8 mm from it's lowest to highest point and it takes 2.5 rotations of the cap to move it, then 1 rotation of the worm gear moves the plunger vertically by 0.01 mm.

This high gear ratio creates an extremely high torque which is useful for the following reasons:
1) no slippage will occur and positional accuracy is maintained.
2) a relatively low torque motor can be used to power this

A height of the toothed portion of the worm wheel sleeve 31 determines the limits of the vertical movement of the plunger 23. Due to the fact that the entirety of the sleeve moves up and down with the plunger (although not at the same rate as detailed below) there is a limit to the maximum achievable vertical movement. This limit simply has to be chosen sufficiently large to allow the positional range to include fully open and fully closed. In an embodiment, the total vertical displacement of the sleeve ends up at about 8 mm (the plunger moves a greater distance at the same time).

The movement of the plunger 23 translates to a flow-rate of fluid from the vessel 10.

As illustrated in FIG. 3c to FIG. 3e, in an embodiment the worm wheel sleeve 31 is configured to go around, or couple to a vessel screw cap 34. In another embodiment, the worm wheel sleeve 31 is part of the vessel screw cap 34. In an embodiment, the vessel screw cap 34 and the plunger 23 form a single, unitary piece.

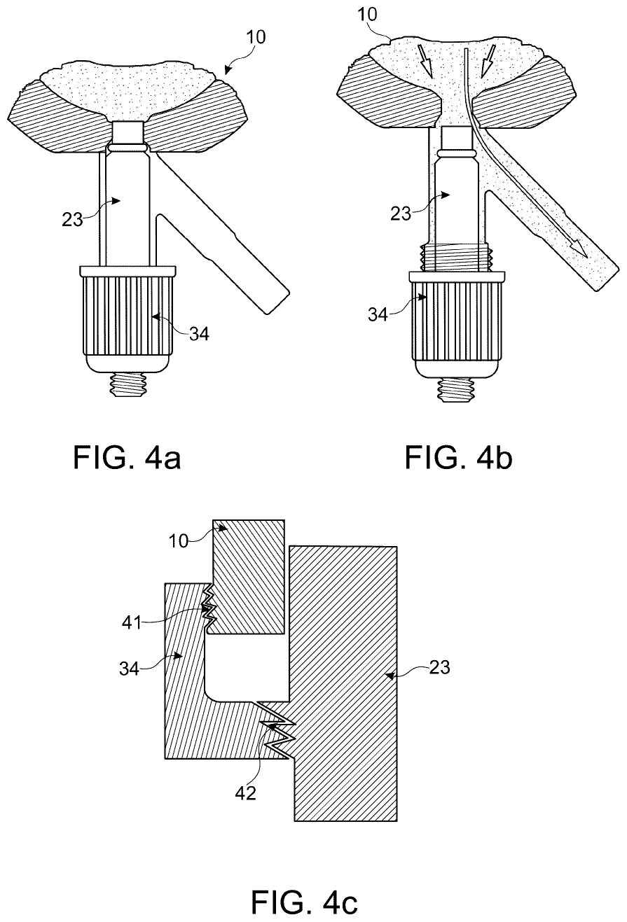

In an embodiment, the vessel screw cap 34 is coupled to the plunger 23, as illustrated in FIG. 4a to 4c.

In an embodiment, the vessel screw cap 34, such as that show in FIG. 2c or FIG. 4a or 4b, has two different sized threads.

FIG. 4a and FIG. 4b show a vessel screw cap 34 coupled to a vessel 10. In FIG. 4a, the vessel screw cap 34 is in a closed position so no fluid leaves the vessel 10. In FIG. 4b, the vessel screw cap 34 is partially open to allow flow of a fluid from the vessel 10.

FIG. 4c shows a partial cross section of the vessel screw cap 34 coupled to both the vessel 10 and the plunger 23. The vessel screw cap 34 has two threads 41 42. The first thread 41 on the vessel screw cap 34 allows it to be screwed onto the chemical vessel 10. The second thread 42 on the vessel screw cap 34 allows it to connect to the plunger 23. In an embodiment, the first thread 41 and the second thread 42 have different pitch sizes.

In an embodiment, the first thread is a clockwise thread and the second thread is a counter-clockwise thread. Alternatively, in an embodiment, the first thread is a counter-clockwise thread, and the second thread is a clockwise thread. The first thread and the second thread are threaded in opposite directions.

As the vessel screw cap 34 is screwed onto the vessel 10, for example by turning it in a clockwise direction, the cap and the plunger will move upwards relative to the vessel according to the pitch of the first thread 41. At the same time, the second thread also engages with the plunger 23, which causes the plunger to move upwards relative to the vessel screw cap 34 according to the pitch of the second thread. Therefore, the linear movement of plunger 23 is much greater than the linear movement of vessel screw cap 34.

When the vessel screw cap 34 is fully screwed on, the plunger 23 is the position which blocks the drainage port 21, as shown in FIG. 2a.

The above embodiments detail a plunger, or piston, type valve. However, the valve can be another type of valve. For example, in an embodiment the valve is a butterfly valve. In the butterfly valve, the closing mechanism is a disc that rotates to isolate or regulates the flow of a fluid. The worm wheel 31 is coupled to the disc, such that a movement of the worm wheel 31 causes the rotation of the disc.

In another embodiment, the valve is a ball valve. In a ball valve, the closing mechanism is a hollow, perforated and pivoting ball. It is open when the ball's hole is in line with the flow inlet and closed when it is pivoted 90-degrees by the valve handle. The worm wheel 31 is coupled to the ball, such that a movement/rotation of the worm wheel 31 causes the pivoting of the ball.

In another embodiment, the valve is a gate valve. In a gate valve, the closing mechanism is a barrier (gate) that is inserted into the path of the fluid to close the valve, and lifted out of the path of the fluid to open the valve. The worm wheel 31 is coupled to the gate, such that a movement/rotation of the worm wheel 31 causes the opening and closing of the gate.

In other embodiments, the valve is a pinch, diaphragm or plug valve.

The present invention provides a solution to the controlled automated opening of valves for vessels by mimicking the rotational action of the screw cap that would be undertaken if the cap/tap were to be manually opened. By providing automation in combination with the worm sleeve and worm screw 32 combination, the movement of the plunger 23, or other closing mechanism, can be tightly controlled, enabling precise volumes of the chemical to be released and passed to another container for further reactions, analysis or use.

In the field of chemistry, a chemist will check the contents of a vessel before taking a decision to drain it. As they are checking the vessel, they often may decide to do it manually. In addition, as many chemists do not have engineering experience, they would not be motivated to replace the manual valve, with which they are familiar, with an automated valve.

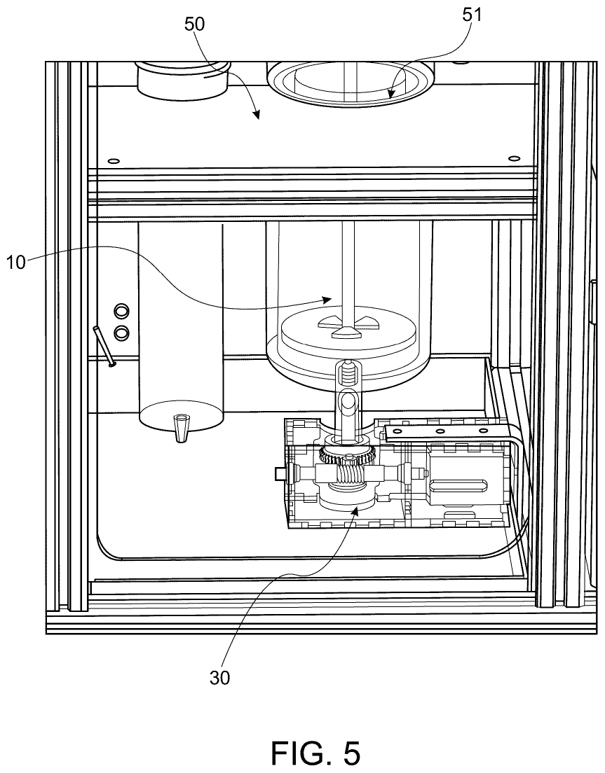

FIG. 5 illustrates a vessel 10 in a holder 50. Vessels 10 are supported in vessel holders 50 during use to keep them stable during use. The opening 51 in the vessel holder to accommodate the vessel 10 often does not exactly fit the vessel, allowing for slight movement of the vessel 10 within the holder 50 under applied force.

The motion caused by the motor 33 as it actuates the worm screw 32 thus may be propagated through the worm screw 32, the work wheel sleeve 31, and the valve 23 attached to the vessel 10 to cause the vessel 10 to shake in the vessel holder 51. This is undesirable for chemical reactions which comprise harmful chemicals and for glass vessels which can easily be damaged. Furthermore, this can cause the threads of the worm screw 32 and the teeth of the worm wheel sleeve 31 to become misaligned.

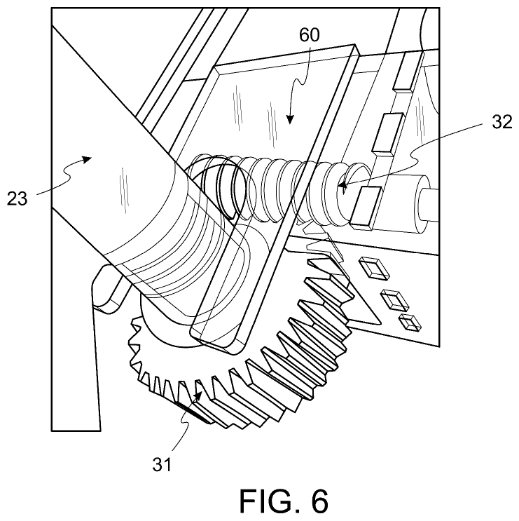

As illustrated in FIG. 6, in an embodiment, the invention comprises a stabilising member 60 that holds the worm screw 32 and the worm wheel sleeve 31 aligned and prevents movement of either component. The stabilising member 60 is made from a material that has sufficient mechanical stability. The stabilising member 60 can be made from highly chemically resistant polymer (such as PTFE) or a resistant steel (like Hastelloy®). The size of the stabilising member 60 is dependent on the size of the vessel 10.

The motor 33 may have manual switches that enable the motor 33 to be turned on and off. In an embodiment, the motor 33 is coupled to a computing device that provides voltage signals to the motor 33.

In an embodiment, the motor 33 is controlled by a motor controller. In an embodiment the automated drain apparatus 30 comprises a micro-controller to control the motor. Alternatively, the micro-controller may be provided on a device externally to the automated drain apparatus 30.

In an embodiment, the motor 33 is a stepper motor. In an embodiment, the motor 33 is controlled with an Allegro A4988.

The motor controller may be in turn be controlled by a computing device, controller, or microcontroller. In an embodiment, there is provided a system comprising the automated drain apparatus 30 and a computing device, the computing device in communication with the motor controller. In an embodiment, the computing device is provided as part of the automated drain apparatus 30

In embodiment, the motor controller may be controlled by an Arduino, Raspberry Pi device, or other such computing device.

In an embodiment, signals are supplied from the computing device to the motor controller as inputs. These signals may comprise the following signals:
1. Enable: high/low on off switch, turned on only for motor action and off otherwise since the apparatus requires no holding torque
2. Direction: high/low switch for clockwise (CW) and counter clockwise (CCW) motion. This signal will indicate whether motion is CW or CCW. For example, a high input could indicate CW and a low input could indicate CCW. Alternatively, a low input could indicate CW and a high input could indicate CCW.
3. Step: high/low switch for which coil pair in the stepper motor has current flowing through it. A low-to-high transition on the Step input advances the motor one increment or step. The number of steps of the motor per full revolution is known and thus the required number of turns becomes a direct function of number of steps.

Homing is achieved by having a switch that triggers a signal to indicate the end position (home) of the motor has been reached. The switch may be a physical switch, a light switch, a magnetic switch or a capacitive switch.

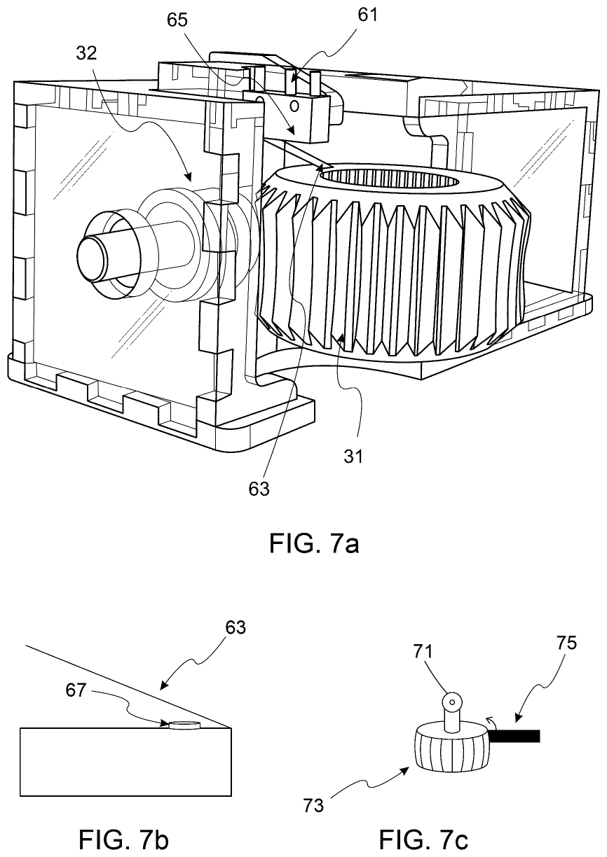

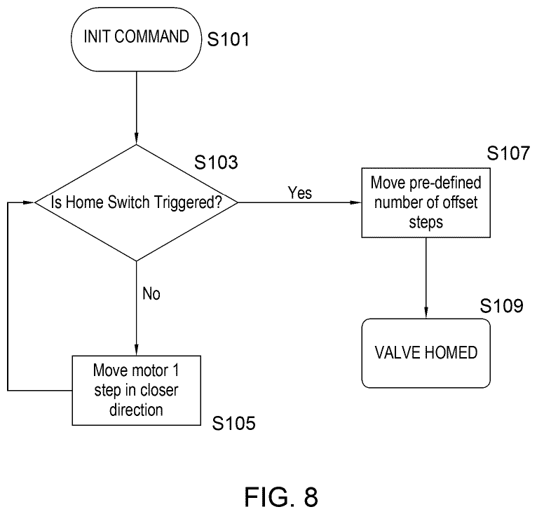

FIG. 7a is a diagram of a further embodiment, where a home switch is provided. For the avoidance of unnecessary repetition, like reference numerals will be used to denote like features. FIG. 7a shows worm wheel 31 which is coupled to worm screw 32. The screw cap 34 and plunger 23 are not shown in FIG. 7a. In FIG. 7a, just the assembly that can be retro-fitted to a vessel is shown.

Switch 61 is a mechanical switch which is positioned such that it triggers before the valve is fully closed. Switch 61 has a flap 63 which extends from the switch body 65. As the worm sleeve rotates, it moves upwards with the screw cap (not shown) of the vessel towards switch 61. As the worm sleeve 31 moves upwards, it engages with flap 63 of switch 61 and the flap moves into the triggering position which is shown in FIG. 7b described below. The controlling software has been programmed with the number of rotations of the worm sleeve 31 necessary to close the valve. Therefore, the controlling software knows how many further rotations are required to close the valve. The controlling software then moves a (user adjustable) number of steps past the point of triggering to fully close the valve.

In the above embodiment, the switch is mechanical. However, the switch can be any type of switch which allows for movement past the trigger point. For example, the switch could be an optical switch or magnetic switch with a hall sensor.

FIG. 7b shows a diagram of the switch 61. The black piece 67 is the actual switch and the flap 63 triggers the switch as it moves towards the switch body 65. The flap triggers the switch at approximately ¾ of its travel. In an embodiment, the switch is a simple 3 pin circuit close. (1 Vcc pin, 1 GND pin and one pin that connects to either of those depending on switch state). That output signal is then detected via an ADC on the control electronics board. The switch could operate with any type of detection mechanism that allows for travel past the trigger point (e.g., laser gate).

The worm sleeve is fitted on the vessel screw cap 34. Thus, there can be variations in the height of the worm sleeve from valve to valve due to differences in the valve and also variations in the top of the worm sleeve with respect to the valve.

In an embodiment, the switch is mounted onto slots, i.e., can be height adjusted to compensate for coarse deviations from one valve to another. As explained above, the lever type switch triggers approximately at the ¾ point of travel thus, it can be actuated past the point of triggering.

In an embodiment, to calibrate a valve during assembly the following steps may be performed:
1. Manually close valve
2. Lower switch along the mounting slots until it audibly triggers.
3. Fasten the switch in place.
4. From software, rotate the valve until switch releases.
5. From software, run home/initialize (which will close the valve until the switch triggers), the switch will now be ‘just’ triggered, but the valve won't be fully in home position (closed in the case of the plunger)
6. From software, incrementally step the valve towards home and record the number of steps it took from the switch triggered position to actual home.
7. From software, set the overshoot steps to the result of 6 (above).
8. The valve is now calibrated. (Run one open-close cycle to verify this).

Thus, in an embodiment, the assembly allows compensation of the manufacturing tolerance stack up from the surrounding components-gearbox, glassware, plunger etc. The exact position of the switch is determined via testing to ensure the switch is triggered before the motor drives past the physical system end stop (i.e. the plunger crashing into the top seated position of the glass). The trigger position is brought as close as possible to this physical end stop, with the software offset providing very fine adjustment beyond the fidelity achievable by hand for drains at this scale.

In summary, some reasons for adding software correction to a physically measured home position are:
higher precision than is reasonably achievable by manually mounting a home switch and
Easier and faster assembly since the switch has to just be in ‘roughly’ the right position and the rest of the tolerance stack is compensated for by calibrating the home position (which could realistically be any position but is most likely the fully open or closed position). This eliminates the needs for assembly jigs, lowers production costs as less precisely manufactured parts can be used, and widens the applicability to third-party equipment to which the assembly can be retro-fitted.

The above has described one embodiment where the closure mechanism of the valve is a plunger. In the arrangement of FIG. 7a, the worm sleeve moves towards the vessel as it is rotated and the worm sleeve engages with the switch 61. However, in other embodiments, the closure mechanism can be a gate (in a gate valve) or a ball (in a ball valve). There would be no movement of the sleeve towards the vessel for ball valves. Likewise, for some gate valve constructions, the actual gate is what moves relative to the position of the handle. However, gate valves can be constructed such that the handle moves with the gate, which ultimately looks very similar to the plunger, except that the assembly is perpendicular to the outlet pipe instead of inline as the plunger. The switch can thus trigger on the position of the worm sleeve as for the plunger.

For valves where the worm sleeve does not move towards the vessel, the worm sleeve can be fitted with a flap or lever that rotates with the worm sleeve. Such an arrangement is shown schematically in FIG. 7c for a ball valve 71, the flap or lever 75 being positioned on the worm sleeve 73 to trigger a switch in the same manner as described for FIG. 7a.

In other embodiments, an initialisation process is manually performed. For example, a user may manually close the value as part of the set up. Then the worm screw is then controlled to open the valve and to count the steps necessary to open the value. The software controlling the valve can then open and close the valve by counting steps.

The advantages of using a switch over the above described manual initialisation are:
The valve needs no human intervention after it has been set up (step counting must assume the valve is closed when the software is started otherwise it has no point of reference to count steps from).
Drift in the motor turns or step loss is corrected for on every close (as the home position is reset) and thus causes no compounding error.
This avoids driving the gears to a physical end stop (collision at closed position of plunger) which otherwise causes localised reaction force spikes on individual gear teeth as the system hits a hard limit, which can increase wear on precision components.

FIG. 8 is a flowchart showing the control processes of the valve. In step S101, an initialisation command is received. It is next determined if the home switch (switch 61 in FIG. 7) has been triggered. If it has not, the motor is moved one step towards the close direction in step S105. Next, the process loops back to step S103 and it checked again to see if the home switch has been triggered. If it has not, the process proceeds to S105 and the loop is followed until it is determined that the home switch is triggered at S103. When it is detected that the home switch has been triggered, the process moves to step S107 where the controlling software retrieves from memory the predefined number of offset steps required to close the valve. The valve is then closed or “homed” in step S109.

In an embodiment, the motor is stepped a single step in close direction while the sensor reading of the home switch has not triggered. This process can be terminated if one of the following two conditions is satisfied:
(i) a pre-defined number of time-out-steps is reached (e.g., it should never take more than 1.5×the maximum travel distance to reach home otherwise there is a mechanical failure); or
(ii) if the sensor indicates that pre-home (trigger) has been reached as explained above. Once the pre-home (trigger) position, is reached the motor is moved a further number of steps (offset) to reach true home. This offset can bet set and saved by the user via the settings section of the firmware, it is then saved to EEPROM (permanent memory) and loaded from EEPROM again on power up.

The present invention may be used to retrofit vessels and their existing valves. Alternatively, in an embodiment, the apparatus may be integrated with a valve, or vessel cap, for use with a vessel.

Any measurements indicated throughout the description or in the Figures are for only example purposes, and other dimensions may be used.

1. An automated drain apparatus for use with a vessel including a valve the automated drain apparatus comprising:
a motor;
a worm screw coupled to the motor, wherein the motor causes a rotation of the worm screw; and
a worm wheel, coupled to the worm screw, wherein the rotation of the worm screw causes a rotation of the worm wheel, wherein the worm wheel is configured to couple to a closing mechanism of the valve so that a rotation of the worm wheel causes a movement of the closing mechanism in the valve to control flow of a fluid out of the vessel.

2. The automated drain apparatus of claim 1, wherein the closing mechanism comprises a plunger, a gate, a ball, or a disc.

3. The automated drain apparatus of claim 1,
wherein a plane of rotation of the worm screw is perpendicular to a plane of rotation of the worm wheel.

4. The automated drain apparatus of claim 1,
wherein the closing mechanism is a plunger or a gate,
wherein a plane of rotation of the worm wheel is perpendicular to a direction of movement of the closing mechanism.

5. The automated drain apparatus of claim 1,
wherein the closing mechanism is a ball or a disc,
wherein a plane of rotation of the worm wheel is parallel to a direction of movement of the closing mechanism.

6. An automated drain apparatus of claim 1, further comprising:
a stabilising member coupled between the worm screw and the worm wheel to maintain an alignment between the worm screw and the worm wheel.

7. The automated drain apparatus of claim 1, further comprising a motor controller, wherein the motor controller is configured to prevent the closing mechanism from overshooting its operational positions.

8. The automated drain apparatus of claim 7, wherein the motor controller is configured to monitor the rotation of the worm screw and retrieve from a memory the amount of rotation necessary to turn the worm screw to allow control movement of the valve to its operational position.

9. The automated drain apparatus of claim 7, further comprising a switch the switch being configured to detect when the position of a valve is in a trigger position, wherein the motor controller is configured to monitor the rotation of the worm screw and retrieve from a memory the amount of rotation necessary to turn the worm screw to allow control of the valve from the trigger position to an operational position.

10. The automated drain apparatus of claim 7, wherein the motor controller is configured to monitor the number of rotations of the worm screw.

11. A tap for a vessel, comprising:
a valve configured to couple to an opening of a vessel, at least part of the valve in fluid communication with the vessel, the valve comprising:
a closing mechanism configured to move so as to control flow of a fluid moving through the valve; and
the automated drain apparatus of claim 1.

12. The tap of claim 11, wherein the closing mechanism is a plunger, the valve further comprising:
a body port in fluid communication with the vessel; and
a drainage port in fluid communication with the body port;
wherein the plunger is configured to move within the body port so as to control flow of a fluid moving from the body port to the drainage port.

13. A vessel for fluids, comprising:
a vessel configured to hold a fluid, the vessel comprising an opening at a bottom of the vessel when in use; and
the tap of claim 11 configured to couple to the opening.
